(19) United States
(12) Patent Application Publication
(10) Pub. No.: US 2021/0397616 A1
(43) Pub. Date: Dec. 23, 2021

(54) FUNNEL ANALYSIS USING A UNIFORM TEMPORAL EVENT QUERY STRUCTURE

(71) Applicant: AT&T Intellectual Property I, L.P., Atlanta, GA (US)

(72) Inventors: Reza Iranmanesh, Middletown, NJ (US); Syed Abbas Alamdar, Middletown, NJ (US); Kaveh Mirzaei, Old Bridge, NJ (US); Saeed Manii, Paramus, NJ (US)

(21) Appl. No.: 16/905,576

(22) Filed: Jun. 18, 2020

(51) Int. Cl. G06F 16/2458; G06F 16/901; G06F 16/9537

(52) U.S. Cl. CPC G06F 16/2474; G06F 16/2477; G06F 16/9537; G06F 16/9024

(57) ABSTRACT

A method includes defining a root node for a funnel analysis query, wherein the query is structured as a graph comprising a plurality of nodes including the root node, wherein the root node comprises a point of origin for at least one funnel of the query, and wherein the root node is constructed to detect a first event that took place within a fixed first time range, defining a non-root node that is connected to the root node, wherein the non-root node is constructed to detect a second event that took place within a second time range that is defined relative to the first time range, performing a funnel analysis on a data set using the query, wherein the funnel analysis tracks an entity through a sequence of events including the first event and the second event, and initiating a remedial action in response to a funnel analysis result.

The present disclosure relates generally to data analysis, and relates more particularly to devices, non-transitory computer-readable media, methods, and temporal, event-based datasets for performing funnel analysis using a uniform temporal event query structure.

### BACKGROUND

Funnel analysis is a method for mapping and analyzing a series of events, usually with a particular interest in the journey of a specific entity or entities through the sequence of events being analyzed. At each step in the sequence, the number of entities satisfying the funnel analysis query may shrink or narrow, like a funnel. For instance, funnel analysis may be used to track users of a website through a login and/or registration process. Being able to perform funnel analysis correctly and efficiently to match various sets of timelines or events can provide unique and invaluable insights into the behaviors of entities such as customers, devices, service providers, and the like.

### SUMMARY

The present disclosure broadly discloses methods, computer-readable media, and systems for performing funnel analysis using a uniform temporal event query structure. In one example, a method performed by a processing system includes defining a root node for a funnel analysis query of an electronic data set, wherein the query is structured as a directed acyclic graph comprising a plurality of nodes including the root node, wherein the root node comprises a point of origin for at least one funnel of the funnel analysis query, and wherein the root node is constructed to detect a first event that took place within a first time range that is fixed, defining, by the processing system, at least one non-root node that is connected to the root node, wherein the at least one non-root node is constructed to detect a second event that took place within a second time range that is defined relative to the first time range, performing a funnel analysis on the electronic data set using the funnel analysis query including the root node and the at least one non-root node, wherein the funnel analysis tracks an entity through a sequence of events including the first event and the second event, and initiating a remedial action with respect to the entity, in response to a result of the funnel analysis.

In another example, a non-transitory computer-readable medium may store instructions which, when executed by a processing system in a communications network, cause the processing system to perform operations. The operations may include defining a root node for a funnel analysis query of an electronic data set, wherein the query is structured as a directed acyclic graph comprising a plurality of nodes including the root node, wherein the root node comprises a point of origin for at least one funnel of the funnel analysis query, and wherein the root node is constructed to detect a first event that took place within a first time range that is fixed, defining, by the processing system, at least one non-root node that is connected to the root node, wherein the at least one non-root node is constructed to detect a second event that took place within a second time range that is defined relative to the first time range, performing a funnel analysis on the electronic data set using the funnel analysis query including the root node and the at least one non-root node, wherein the funnel analysis tracks an entity through a sequence of events including the first event and the second event, and initiating a remedial action with respect to the entity, in response to a result of the funnel analysis.

In another example, a device may include a processing system including at least one processor and a non-transitory computer-readable medium storing instructions which, when executed by the processing system when deployed in a communications network, cause the processing system to perform operations. The operations may include defining a root node for a funnel analysis query of an electronic data set, wherein the query is structured as a directed acyclic graph comprising a plurality of nodes including the root node, wherein the root node comprises a point of origin for at least one funnel of the funnel analysis query, and wherein the root node is constructed to detect a first event that took place within a first time range that is fixed, defining, by the processing system, at least one non-root node that is connected to the root node, wherein the at least one non-root node is constructed to detect a second event that took place within a second time range that is defined relative to the first time range, performing a funnel analysis on the electronic data set using the funnel analysis query including the root node and the at least one non-root node, wherein the funnel analysis tracks an entity through a sequence of events including the first event and the second event, and initiating a remedial action with respect to the entity, in response to a result of the funnel analysis.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for performing funnel analysis using a uniform temporal event query structure may operate;

FIG. 2 illustrates a flowchart of an example method for performing a funnel analysis, in accordance with the present disclosure;

FIG. 3 illustrates an example hyperfunnel query according to the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

As discussed above, funnel analysis is a method for mapping and analyzing a series of events, usually with a particular interest in the journey of a specific entity through the sequence of events being analyzed. At each step in the sequence, the number of entities satisfying the funnel analysis query may shrink or narrow, like a funnel. For instance, funnel analysis may be used to track users of a website through a login and/or registration process. Being able to perform funnel analysis correctly and efficiently to match various sets of timelines or events can provide unique and invaluable insights into the behaviors of entities such as customers, devices, service providers, and the like.

However, as the amount of data a funnel analysis has access to (e.g., a number of data sources such as databases, tables, and the like in a data lake or other big data environment) increases, it becomes increasingly difficult to perform funnel analysis in an accurate and efficient manner. This is due, at least in part, to the various cross examinations and correlations that must be performed between large numbers of heterogeneous datasets.

For instance, in order to find all modems that match a specified timeline, tens of databases for different systems (e.g., inventory systems, customer care systems, activation and billing systems, reverse logistics systems, hardware event databases, dispatch databases, and the like) and hundreds of tables may need to be analyzed and correlated. Similarly, to track all web site users whose behavior matches a specified timeline, many databases and tables (e.g., registration databases, login databases, product purchase databases, referral databases, and the like) may need to be analyzed. Correlating these multiple data sources typically requires vast domain knowledge and query expertise.

Moreover, due to the complexity of conventional funnel analysis methods, most queries set a single, fixed timeline for the sequence of events as a whole (e.g., the entire sequence of events being analyzed must be completed between a first date and a second date). For instance, a query to track web site users through the sequence of registration, login, and product purchase may be subject to a fixed range of dates (e.g., Mar. 1, 2020 to Mar. 30, 2020). Applying this fixed date range to the analysis as a whole may introduce a bias into the analysis, however. For instance, a first customer who registers with the web site on Mar. 1, 2020 has twenty-nine days to complete the sequence of events (e.g., to login and purchase a product), whereas a second customer who registers with the web site on Mar. 30, 2020 has only one day to complete the sequence of events. Even if the second customer logs in and purchases a product two days after registering (e.g., on Apr. 1, 2020), these actions would be missed by the “funnel.”

Examples of the present disclosure provide a uniform temporal event query structure for performing funnel analysis that reduces the complexity of correlating multiple data sources (e.g., databases and/or tables) and also reduces bias in the analysis. The unified approach disclosed herein enables full abstraction of correlations from the underlying data structures and dataset schemas and also enables data analysts to track a graph of events rather than a single chain of events during the funnel analysis. Based on a result of the graph of events (e.g., a termination point of a sequence of events traced by the graph), a remedial action may be taken. Because the remedial action is based on the result of a funnel analysis that is performed in the manner disclosed, the remedial action is more likely to rectify any issues detected in less biased manner.

In one example, the present disclosure includes a pre-aggregation phase and a post-aggregation phase. The pre-aggregation phase may create a plurality of predefined, uniform temporal queries (hereinafter referred to as “pivot queries”) for each event in a sequence of events that is being analyzed. In one example, each pivot query may report a global unique identifier, an exact time, zero, one, or a plurality of attributes, and at least one entity identifier.

The post-aggregation phase may use one or more predefined pivot queries to construct a funnel analysis query with a first (single) temporal event having a fixed date range (e.g., Mar. 1, 2020 to Mar. 30, 2020) as a root. A series (for a single sequence of events originating with the first temporal event) or a directed acyclic graph (for a plurality of possible sequences of events originating with the first temporal event) may then extend from the root and specify one or more additional temporal events. The date range for each of the additional temporal events may be defined relative to any previously configured temporal event in the series or directed acyclic graph (e.g., relative to the fixed date range of the first temporal event or relative to any of the additional temporal events). For instance, the date range for a second temporal event may be defined as within x days before or after the first temporal event, or x days before or after a third temporal event, etc. Thus, biases inherent in conventional funnel analysis queries that define a single fixed, overall timeline for the query as a whole can be greatly reduced.

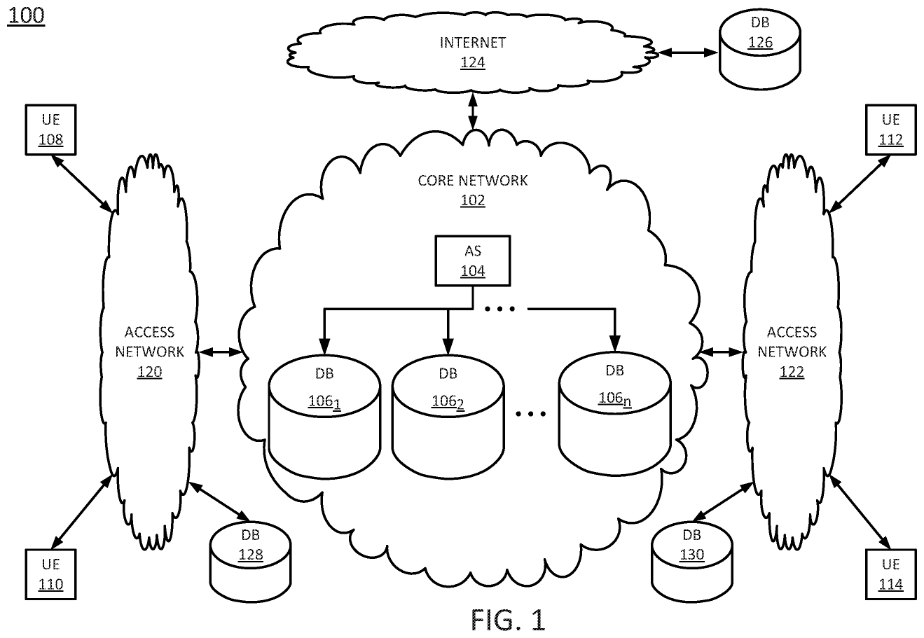

Once a funnel analysis query has been configured in the manner disclosed, correlation queries may be automatically generated and used to query a plurality of data sources one by one. The results of each query to each data source may be stored as a dynamic table, such that a sequence of y events produces y dynamic tables, where each line (row) of each dynamic table represents an entity or group of entities that match the timeline of the query up to the event corresponding to the dynamic table. Each column of the dynamic table may contain an attribute for the entities or groups of entities. These and other aspects of the present disclosure are discussed in greater detail below in connection with the examples of FIGS. 1-4.

Within the context of the present disclosure, an “entity” is understood to refer to a noun or object of interest in a system. An “event” is understood to refer to a status or state of one or more entities at a certain point in time. Furthermore, a “funnel” is understood to refer to a funnel analysis in which the query comprises a single sequence of temporal events originating with a first temporal event. A “hyperfunnel” is understood to refer to a funnel analysis in which the query comprises a plurality of (e.g., at least two) different funnels or sequences of temporal events that originate with and diverge from the same first temporal event. The structure of a funnel query may be referred to as a “series,” while the structure of a hyperfunnel query may be referred to as a “directed acyclic graph” (due to the multiple different sequences branching off in different directions from the first temporal event).

To further aid in understanding the present disclosure, FIG. 1 illustrates an example system 100 in which examples of the present disclosure for digital watermarking may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104 and a plurality of databases (DBs) 106₁-106ₙ (hereinafter individually referred to as a “database 106” or “DB 106” or collectively referred to as “databases 106” or “DBs 106”). For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114 and the AS 104, other components of the core network 102, devices reachable via the Internet in general, and so forth. In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like.

The access networks 120 and 122 may also be in communication with one or more databases (DBs) 128 and 130, respectively. For instance, the DBs 128 and 130 may include customer databases for service providers, user databases for web sites, student databases for educational institutions, employee databases for enterprises, inventory systems, customer care systems, activation and billing systems, reverse logistics systems, hardware event databases, dispatch databases, and sources of various other types of data.

In one example, one or more databases (DBs) 126 may be accessible to the AS 104 via Internet 124 in general. The databases may be associated with Internet content providers, e.g., entities that provide content (e.g., new, blogs, videos, music, files, ecommerce, or the like) in the form of websites to users over the Internet 124. Thus, some of the databases 126 may store data relating to user histories associated with specific web sites (e.g., how long users have been registered with the web sites, how frequently the users log into the web sites, how often the users make purchases through the web sites, how frequently the users upload content to the web sites, etc.).

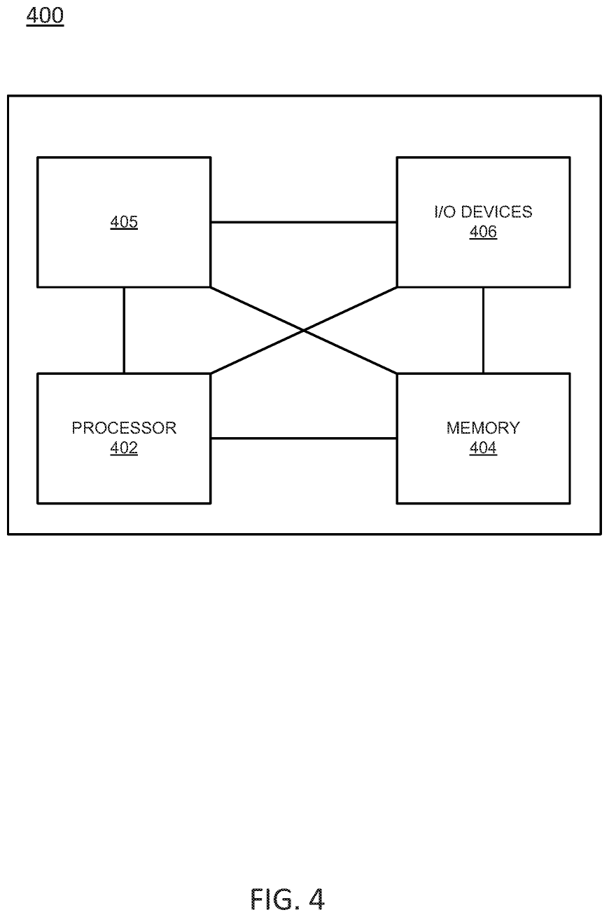

In accordance with the present disclosure, the AS 104 may be configured to provide one or more operations or functions in connection with examples of the present disclosure for performing funnel analysis using a uniform temporal event query structure, as described herein. The AS 104 may comprise one or more physical devices, e.g., one or more computing systems or servers, such as computing system 400 depicted in FIG. 4, and may be configured as described below to construct and execute funnel analysis queries. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the AS 104 may be configured to construct a funnel analysis query and execute the funnel analysis query against an underlying data set. The underlying data set may be distributed across a plurality of data sources, such as the databases 106, 126, 128, and 130. For instance, in one example, underlying data set may include records from one or more service providers (e.g., mobile communications service providers, Internet service providers, electronic device manufacturers, etc.). The plurality of data sources may all be located in a common geographic location, or the plurality of data sources may be geographically distributed across a plurality of geographic locations.

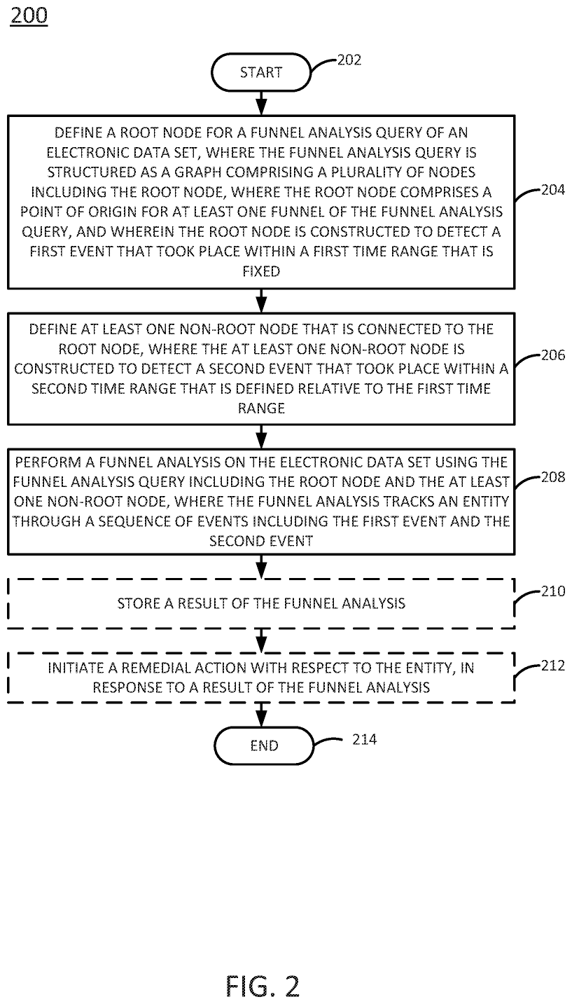

As discussed in further detail below, the AS 104 may construct a funnel analysis query by connecting a plurality of predefined, uniform temporal queries (also referred to here as “pivot” queries) in order to define one or more sequences of events. The AS 104 may then execute the funnel analysis query against the underlying data set by querying the underlying data set for data related to entities that match at least one of the one or more sequences of events. One specific example of a method for performing funnel analysis according to the present disclosure is described in greater detail in connection with FIG. 2.

The DBs 106 may store data for a plurality of different entities. For instance, the DBs 106 may include customer databases for service providers, user databases for web sites, student databases for educational institutions, employee databases for enterprises, inventory systems, customer care systems, activation and billing systems, reverse logistics systems, hardware event databases, dispatch databases, and sources of various other types of data.

In one example, at least some of the DBs 106 may comprise a physical storage devices integrated with the AS 104 (e.g., database servers or file servers), or may be attached or coupled to the AS 104, in accordance with the present disclosure. In one example, the AS 104 may load instructions into a memory, or one or more distributed memory units, and execute the instructions for performing funnel analysis using a uniform temporal event query structure, as described herein.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

In one example, the building block of the disclosed funnel analysis technique is referred to as a “pivot query.” In one example, a pivot query is used to model an underlying data set and may comprise a point of origin for at least one funnel of a funnel analysis. Multiple pivot queries may be arranged together in a directed acyclic graph to form a funnel or a hyperfunnel, as discussed in further detail below. In one example, the pivot query may be one of two types of pivot queries: an event query or a static query.

In one example, an event query is constructed to detect entity attributes that change over time. An event query may be constructed to report a list of one or more entity identifiers that play a role in an event for which the query is defined. For instance, a pivot query related to a modem installation may be defined within the context of the modem that is being installed and the customer who is installing the modem. A pivot query related to a modem swap (deactivation) may be defined within the context of the old modem that is being replaced, the new modem that is being installed, and the customer who is swapping the modem. An event query may be further configured to detect and/or report an event timestamp, where the event timestamp defines an exact time (e.g., to the lowest time granularity that is feasible or desirable) at which the event took place. The event query may be further configured to detect and/or report a globally unique identifier and zero, one, or multiple attributes of the entity. For instance, where the pivot query relates to a modem installation, an attribute of the query may comprise the location of the modem in a house, a length of the cable, or another attribute of the modem. In one example, an event query describes no more than one type of event.

In one example, a static query detects timeless attributes of an entity or a combination of entities. For instance, a modem's model number is a timeless attribute, i.e., a constant that does not change with time. In one example, a static query may be configured to detect and/or report an entity identifier (e.g., where the entity is a modem, the entity identifier may comprise the modem's serial number). In some examples, a static query may include a composite key of multiple entity identifiers defining attributes for a combination of entities. A static query may be further configured to detect and/or report one or more attributes of the entity (e.g., where the entity is a modem, an attribute of the entity may comprise the modem's model name). It should be noted that many entity attributes may be subject to change, either frequently (e.g., as in the case of an outside temperature) or infrequently (e.g., as in the case of a customer's name). Thus, in one example, attributes may be extracted as part of an event query.

In one example, the pivot query may also be a derived pivot query, e.g., a pivot query that is the result of a combination of aggregate functions, calculated columns, and filters applied on another pivot query. Both event queries and static queries can be used in a derived query. A derived query over a static pivot query will be a static query and will comply with the definition of a static query, described above. A derived query over an event query will inherently also be an event query.

In one example, the pivot query may be aggregated over a plurality of columns of data for a plurality of entities and (when the pivot query is an event query) over the event time. In one example, each entity attribute (e.g., column of the underlying data set) that contributes to the result of the pivot query will have an aggregator defined on top of the field.

In one example, an aggregation function may be used to create a pivot query with a lower time granularity. For instance, a pivot query may be defined to report the exact time that a modem was rebooted. The pivot query in the case might report the unique identifier for the query, the serial number of the modem, the exact time at which the modem was rebooted, central processing unit (CPU) usage of the modem at the time of reboot, and memory usage of the modem at the time of reboot. In order to create a derived query to report the number of daily reboots, a derived query may be defined to convert the original pivot query (reporting the exact time at which the modem was rebooted) to a query that reports the unique identifier for the query, the modem serial number, the date on which the modem was rebooted to the granularity of a day, the number of reboots of the modem, the minimum reboot CPU usage of the modem, the maximum reboot CPU usage of the modem, the minimum reboot memory usage of the modem, and the maximum reboot memory usage of the modem. In one example, all aggregation functions that are applied on the CPU usage and memory usage attributes (e.g., minimum, maximum, and counts) are borrowed directly from an underlying structured query language (SQL) engine. Thus, the result of the pivot query in this case may be produced by an SQL command using the aggregate functions and a group by statement.

In another example, an aggregation function may be used to reduce the number of entity attributes (e.g., columns of the underlying data set) in the pivot query, with the possibility of lowering event time granularity at the same time (e.g., where the pivot query is an event query). For instance, a pivot query may be defined to report the exact time that a technician was dispatched to a customer's home. The pivot query might report a unique identifier for the query, an exact time at which the technician was dispatched, a customer identifier, and a technician identifier. In order to create a derived query to report the number of daily dispatches per technician, a derived query may be defined to convert the original pivot query (reporting the exact time that a technician was dispatched to a customer's home) to a query that reports the unique identifier for the query, a date on which the technician was dispatched (with a granularity of a day), a technician identifier, and a number of dispatches. The derived query could, like the derived query discussed above with respect to the modem reboots, be constructed using aggregation functions (e.g., group and count by) provided by an underlying SQL engine.

In one example, a filter may be applied on top of a pivot query that is a derived query. This may allow a predefined pivot query to be “customized” for use in a specific funnel analysis query. For instance, the pivot query may be an event query related to an installation of a modem and may report a query identifier, an installation time, a customer identifier, a modem serial number, and a modem model number. In this case, the pivot query could be filtered to report only event queries for specified modem model numbers. For event queries that report event times, two filters in particular may be useful: the time of the very first event and the time of the very last event that occurs with respect to the unique entity combination specified by the query.

In one example, at least one calculated value may be computed based on the underlying data set, In one example, computation of a derived value involves applying a formula to one or more entity attributes (e.g., columns of the underlying data set). For instance, a calculated value may comprise a ratio that is computed by dividing a first entity attribute by a second entity attribute (e.g., maximum reboot CPU usage/minimum reboot CPU usage).

As discussed above, a hyperfunnel analysis may be performed by combining and correlating pivot queries. When correlating pivot queries, the most important elements to compare may be the timestamps of the pivot queries (if the pivot queries being correlated are event queries) and the entities that are involved in the pivot queries. The hyperfunnel may then be constructed as a directed acyclic graph of correlated pivot queries; however, the hyperfunnel may be represented using a directed acyclic graph that includes a plurality of nodes (starting with a pivot query as a root node). Each node of the directed acyclic graph (e.g., each correlated pivot query), once executed, will produce a tabular result data set (e.g., where each row of the table may correspond to an entity whose attributes match every node of the hyperfunnel up to that node, and each column of the table may correspond to an attribute of the entities identified in the table).

Each result data set may be input to the next node in the directed acyclic graph (sometimes along with other inputs such as result data sets of other pivot queries, sometimes by itself). Thus, each node's respective result data set represents the chain of contributing events that have or have not taken effect up to the point of the hyperfunnel represented by the node. Thus, a row of a result data set may contain multiple timestamps, where each timestamp indicates the time that a particular event in the chain of contributing events took place.

Moreover, each row of a result data set represents an instance of the specific chain of contributing events that the corresponding node was built to detect. Each node's result data set may be stored and reused as a pivot query in other portions of a current hyperfunnel or in other hyperfunnels. For instance, if a node represents a chain of n events that are taking place, then, in theory, n different pivot queries could be created from the node's result data set. As an example, a node may define all modems that have been removed from customers' homes, have been received in a warehouse, and have not been installed in other homes between removal and receipt in the warehouse. At least two pivot queries can be created from the result data set of this node: (1) all modem receipt events that are the result of removal of a modem from a customer's home (with customer identifier and modem serial number as entities); and (2) all modem deactivation events in which the modem went directly to a warehouse (with customer identifier and mode, serial number as entities). Pivot queries that are constructed from the result data set of another pivot query may be referred to as “piped” pivot queries.

FIG. 2 illustrates a flowchart of an example method 200 for performing a funnel analysis, in accordance with the present disclosure. In one example, steps, functions and/or operations of the method 200 may be performed by a device as illustrated in FIG. 1, e.g., AS 104 or any one or more components thereof. In one example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system, such as processing system 402.

The method 200 begins in step 202 and proceeds to step 204. In step 204, the processing system may define a root node for a funnel analysis query of an electronic data set (i.e., a data set stored in electronic form, potentially across a plurality of data sources), where the funnel analysis query is structured as a graph comprising a plurality of nodes including the root node, where the root node comprises a point of origin for at least one funnel (sequence of events) of the funnel analysis query, and wherein the root node is constructed to detect a first event that took place within a first time range that is fixed (i.e., the starting and ending dates for the first time range are specific dates, as opposed to the occurrence of the first time range being open ended). Thus, the root node for the funnel analysis query may comprise a pivot query that is an event query, as discussed above. In one example, the root node will be the only node in the funnel analysis query that defines or is associated with a fixed time range.

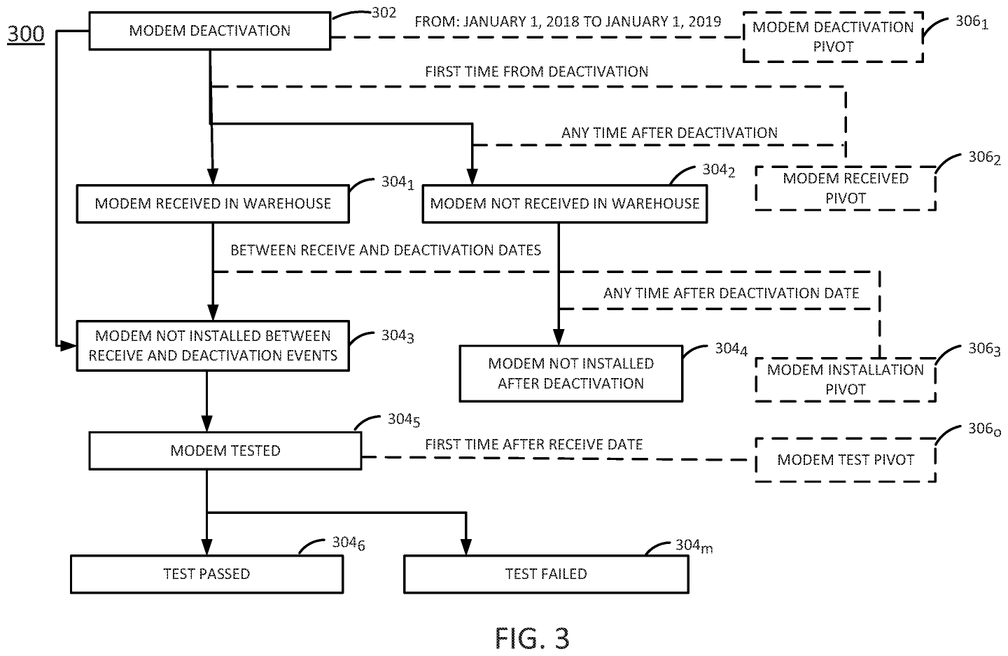

FIG. 3, for instance, illustrates an example hyperfunnel query 300 according to the present disclosure, where the example hyperfunnel query 300 includes a root node 302. The example hyperfunnel query 300 is designed to trace deactivated modems. In the example of FIG. 3, the root node 302 is constructed to detect a modem deactivation as the event. The modem deactivation event may be defined by assigning a fixed date range (e.g., between Jan. 1, 2018 and Jan. 1, 2019) to an existing “modem deactivation” pivot query 306₁.

If extra attributes are present in an existing pivot query that is selected as the root node, then, in one example, these extra attributes may be included in the root node. The root node's result data set may include the event identifier of the selected pivot query (e.g., “modem deactivation”), the event timestamp of the selected pivot query, the entities of the selected pivot query, and any attributes that may be chosen from the selected pivot query for inclusion in the root node.

Referring back to FIG. 2, in step 206, the processing system may define at least one non-root node that is connected to the root node, where the at least one non-root node is constructed to detect a second event that took place within a second time range that is defined relative to the first time range (i.e., the starting and ending dates for the second time range may not be specific dates, but may occur within some defined window relative to the first time range). In one example, a non-root node may comprise a branch node (i.e., a node that has at least one child nodes) or a leaf node (i.e., a node that has no child nodes).

For instance, referring again to the example of FIG. 3, the example hyperfunnel query 300 may include a plurality of non-root nodes 304₁-304ₘ (hereinafter individually referred to as a “non-root node 304” or collectively referred to as “non-root nodes 304”). In the example of FIG. 3, a first non-root node 304₁ is constructed to detect an event of receiving a deactivated modem in a warehouse. The modem receipt event may be defined by assigning a date range that is relative to the fixed date range of the root node 302 (e.g., first time after deactivation) to an existing “modem received” pivot query 306₂. Thus, the first non-root node 304₁ may comprise the first non-root node of a first branch of the hyperfunnel query 300.

Similarly, a second non-root node 304₂ is constructed to detect an event of not receiving a deactivated modem. Like the modem receipt event discussed above, the non-receipt of modem event may be defined by assigning a date range that is relative to the fixed date range of the root node 302 (e.g., any time after deactivation date) to the existing “modem received” pivot query 306₂. Thus, the same existing pivot query (e.g., the “modem received” pivot query 306₂) may be used to define two (or more) different events by adjusting the assigned date range or other attributes. In the example of FIG. 3, the second non-root node 304₂ may comprise the first non-root node of a second branch of the hyperfunnel query 300.

Each of the first non-root node 304₁ and the second non-root node 304₂ may be followed by one or more additional non-root nodes 304 (i.e., child nodes) as shown. The additional non-root nodes may define further events and further date ranges that are defined relative to at least one of the preceding non-root nodes 304. For instance, the first non-root node 304₁ may be connected to a third non-root node 304₃, while the second non-root node 304₂ may be connected to a fourth non-root node 304₄. The third non-root node 304₃ may, in turn, be connected to a fifth non-root node 304₅, while the fourth non-root node 304₄ may be a leaf node in the example of FIG. 3. The fifth non-root node 304₅ may, in turn, be connected to a sixth non-root node 304₆ and an mth non-root node 304ₘ. Thus, additional branches of the hyperfunnel query 300 may branch out from non-root nodes 304.

In the example of FIG. 3, the third non-root node 304₃ is constructed to detect an event of a deactivated modem not being installed between the modem deactivation event and the modem received event. The modem not installed event may be defined by assigning a date range that is relative to the fixed date range of the root node 302 and the relative date range of the first non-root node 304₁ (e.g., between receive date and deactivation date) to an existing “modem installation” pivot query 306₃.

The fourth non-root node 304₄ is constructed to detect an event of a deactivated modem that is not received in the warehouse not being installed. The modem not installed event may be defined by assigning a date range that is relative to the fixed date range of the root node 302 and the relative date range of the second non-root node 304₂ (e.g., any time after deactivation date) to the existing “modem installation” pivot query 306₃. Thus, again, the same existing pivot query (e.g., the “modem installation” pivot query 306₃) may be used to define two (or more) different events by adjusting the assigned date range or other attributes.

The fifth non-root node 304₅ is constructed to detect an event of a modem that has not been installed between activation and receipt in a warehouse being tested. The modem tested event may be defined by assigning a date range that is relative to the relative date range of the third non-root node 304₃ (e.g., first time after receive date) to an existing “modem test” pivot query 306ₒ.

The sixth non-root node 304₆ is constructed to detect an event of a tested modem passing testing, while the mth non-root node 304ₘ is constructed to detect an event of a tested modem failing testing. The test passed event and the test failed event may not be defined using existing pivot queries. Both the sixth non-root node 304₆ and the mth non-root node 304ₘ may comprise leaf nodes.

In the example of FIG. 3, the combination of the first non-root node 304₁, the third non-root node 304₃, the fifth non-root node 304₅, the sixth non-root node 304₆, and the mth non-root node 304ₘ may define a first branch of the hyperfunnel query 300 (with the sixth non-root node 304₆ and the mth non-root node 304ₘ defining further sub-branches of the first branch), while the combination of the second non-root node 304₂ and the fourth root node 304₄ may define a second branch of the hyperfunnel query 300.

Thus, as illustrated in FIG. 3, additional branches of the hyperfunnel query 300 may branch out from non-root nodes, similar to the manner in which a piped pivot query may be created (discussed above). However, in the case where a non-root node serves as a branching off point (i.e., is a branch node having at least two child nodes), the branching off may not result in columns of data being removed from the parent non-root node's result data set (a child non-root node may, however, add a new column to the parent non-root node's result data set). As a simple example, multiple child non-root nodes may branch out from a parent non-root node that reports modem deactivations, where each of the child non-root nodes reports deactivations for a different modem model number.

In one example, a new non-root node can be defined by branching from a single-event pivot query (i.e., an existing node, which may be a root node or a non-root node) and selecting a single new pivot query to join with the existing node. In one example, the new pivot query is an event query. In this case, the processing system may first specify at least one shared entity field between the result data set of the existing node and the new pivot query to be joined with the existing node.

Next, the processing system may specify the event timestamp field (from the existing node's result data set) which is to be used for a time comparison against the new pivot query.

Next, the processing system may specify a time granularity for the comparison between the existing node and the new pivot query (e.g., hours, days, months, etc.). For instance, if the time granularity of a day is selected, then the event timestamps for the existing node and the new pivot query may be converted to days, which may allow the difference between the timestamp for the existing node and the timestamp for the new pivot query to be calculated as whole numbers (e.g., the number of days between the events corresponding to the existing node and the new pivot query.

Next, the processing system may specify a numerical range of positive integers of interest. For instance, if the range [1, ∞) is specified for the granularity of days, this would indicate that only events from the pivot queries that happen on or after six days of the existing node's result data set should be considered by the new pivot query. In this case, negative numbers may be used to indicate that the event associated with the new pivot query happens before the timestamp of the existing node's result data set.

Next, if any rows of the result data sets for the new pivot query share the exact same value (e.g., entity identity), then the processing system may select the row having the smallest value for the arithmetic absolute of the difference between the timestamp of the existing node's result data set and the new pivot query's result data set.

Next, the processing system may make sure that no event is detected for the same value (e.g., entity identity) in the new pivot query that occurs between the time stamp of the existing node's result data set and the new pivot query's result data set.

In another example, a new non-root node can be defined by a process referred to herein as “in-between joining.” The idea behind in-between joining is that, instead of defining a relative time in terms of numbers (e.g., between x and y days after the event of the parent node), an in-between check can be defined. This can be achieved by branching from a multiple-event pivot query (i.e., an existing node, which may be a root node or a non-root node, having a plurality of timestamps as the resulting contribution of a plurality of previous pivot queries in the existing node), joining with a new pivot query over a set of entities, and verifying whether the new pivot query took place between a pair of the plurality of timestamps of the existing node over a matching set of entities. For instance, in the example of FIG. 3 (discussed above), the non-root node 304₃ may be defined by an in-between joining process.

For example, an analyst may wish to join all modems received in a warehouse after deactivation events (represented by an existing node) with all instances of modem test events in the warehouse (represented by a new node/pivot query) which do not (or, for other examples, which do) include a modem activation event (represented by a new node/pivot query which may be a piped pivot query) happening in between the modem received event and the modem test event.

The new result data set from the new non-root node would contain all of the existing columns of data of the parent node's result data set, plus all of the columns of data from the joined new pivot query. Thus, a single node of a funnel analysis query may branch off from multiple (e.g., two) parent nodes plus a pivot query, which is accommodated by the directed acyclic graph structure. Alternatively, a single node could branch from a single parent node plus two pivot queries, which also is accommodated by the directed acyclic graph structure. In another example, a non-root node can be joined with a static pivot query. In this case, there may be a many-to-one or a one-to-one relationship between the existing node and the static pivot query the existing node is being joined with. In relational database terms, a join tends to have a de-normalizing effect. In one example, the join is performed on all available entity identifiers of the static pivot query; thus, all of the entities associated with the static pivot query should be present in the existing node in this case.

In step 208, the processing system may perform a funnel analysis on the electronic data set using the funnel analysis query including the root node and the at least one non-root node, where the funnel analysis tracks an entity through a sequence of events including the first event and the second event. As discussed above, as the funnel analysis proceeds along a branch of the funnel analysis query, the number of results reported may narrow or decrease with each node that processes the data set.

In optional step 210 (illustrated in phantom), the processing system may store a result of the funnel analysis, e.g., in a database. In one example, the processing system may compute a unique count of entities reported by each node of the funnel analysis query. The counts may be used to construct a Sankey diagram, a sunburst diagram, or another graphic representation of the funnel.

In optional step 212 (illustrated in phantom) the processing system may initiate a remedial action with respect to the entity, in response to a result of the funnel analysis performed in step 208. For instance, where the result of the funnel analysis indicates that a customer of a telecommunications service provider has not returned a deactivated item of equipment (e.g., a modem) to the service provider's warehouse, the processing system may generate a reminder to an operations system that a notification should be sent to the customer or a notification is automatically generated and sent to the customer. Where the deactivated equipment has not been received in the warehouse but is detected to have been activated or installed elsewhere (e.g., at an unauthorized location), the processing system may generate a signal to deactivate the equipment. Where the deactivated equipment was returned to the warehouse and was tested, but is detected to have failed the test, the test results may be correlated with the test results of other returned equipment to detect a common failure. The processing system may then send a signal to test the equipment that remains in the field (i.e., still activated at customer premises) for the common failure, to deactivate the equipment that remains in the field to prevent the common failure, to install software to prevent the common failure, or to take other actions. These example remedial actions are only illustrative for the example scenario as discussed above. As such, other relevant remedial actions can be deployed based on the events and/or behaviors that are detected for the given scenario.

In another example where the funnel analysis tracks users of a web site, the funnel analysis may detect when a user account has been inactive for a threshold period of time (e.g., no logins, no activity, no purchases, etc.). In this case, the processing system may initiate a remedial action such as sending a message to the user to determine whether the account should be maintained or to encourage the user to take some action with respect to the account (e.g., a request to verify account recovery information, a request to ask the customer to reset his or her password, a coupon or discount to encourage the customer to make a purchase, or the like). In an example where the funnel analysis detects unusual activity in the user account, the processing system may send a message to the user to ask the user to review or verify account information (e.g., activities, purchases, login dates, etc.) or may temporarily suspend the account (e.g., prevent logins using the account) until the user can review the unusual activity and so on.

The method 200 may end in step 214.

Thus, examples of the present disclosure construct a funnel analysis query as a directed acyclic graph comprising a plurality of nodes and a plurality of links. The root node of the graph may be defined with a first date range that is static or fixed. However, the non-root nodes that branch out from the root node may be defined with date ranges that are relative compared to the first date range. The links between nodes may indicate an order in which the nodes of the graph are to be traversed or executed against the underlying data set. Thus, starting from the root node of a funnel analysis query, it is possible to determine exactly what time ranges from each data set are required to make execution of the hyperfunnel for an entire fixed date range possible. For larger data sets, it may also be possible to partition a funnel analysis query over the fixed date range of the root node and report the results for each partition.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for performing a funnel analysis using a uniform temporal event query structure, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for performing a funnel analysis using a uniform temporal event query structure (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for performing a funnel analysis using a uniform temporal event query structure (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
defining, by a processing system including at least one processor, a root node for a funnel analysis query of an electronic data set, wherein the funnel analysis query is structured as a directed acyclic graph comprising a plurality of nodes including the root node, wherein the root node comprises a point of origin for at least one funnel of the funnel analysis query, and wherein the root node is constructed to detect a first event that took place within a first time range that is fixed;
defining, by the processing system, at least one non-root node that is connected to the root node, wherein the at least one non-root node is constructed to detect a second event that took place within a second time range that is defined relative to the first time range;
performing, by the processing system, a funnel analysis on the electronic data set using the funnel analysis query including the root node and the at least one non-root node, wherein the funnel analysis tracks an entity through a sequence of events including the first event and the second event; and
initiating, by the processing system, a remedial action with respect to the entity, in response to a result of the funnel analysis.

2. The method of claim 1, wherein a starting date and an ending date for the first time range are specific dates.

3. The method of claim 2, wherein a starting date and an ending date for the second time range occur within a defined window relative to the first time range.

4. The method of claim 1, wherein the at least one funnel defines a sequence of events involving an entity comprising an object of interest.

5. The method of claim 4, wherein as the funnel analysis proceeds along the at least one funnel, a number of results reported by the funnel analysis query narrows with each node of the root node and the at least one non-root node that processes the electronic data set.

6. The method of claim 1, wherein the at least one non-root node is constructed to detect a second event that took place within a second time range that is fixed.

7. The method of claim 6, wherein the at least one non-root node is constructed to report at least one selected from a group of: an entity identifier of an entity involved in the second event, a timestamp indicating when the second event took place, a globally unique identifier for the at least one non-root node, and an attribute of the entity.

8. The method of claim 1, wherein the at least one non-root node is constructed to detect an attribute of an entity that does not change.

9. The method of claim 8, wherein the at least one non-root node is constructed to report at least one selected from a group of: an entity identifier of an entity involved in the second event and the attribute.

10. The method of claim 1, wherein at least one of the root node and the at least one non-root node is constructed by selecting a predefined pivot query from a plurality of predefined pivot queries.

11. The method of claim 10, wherein the at least one of the root node and the at least one non-root node is further constructed by applying a filter on top of the predefined pivot query to customize a set of entity attributes reported by the predefined pivot query.

12. The method of claim 1, wherein the at least one non-root node comprises:
a first non-root node defining a first funnel of the at least one funnel that branches off from the root node; and
a second non-root node defining a second funnel of the at least one funnel that branches off from the root node,
wherein the first funnel and the second funnel define separate sequences of events.

13. The method of claim 1, wherein the root node outputs a first data set comprising a plurality of columns of data, wherein a first column of the plurality of columns of data contains entities related to the first event, and wherein a second column of the plurality of columns of data contains an attribute of the entities.

14. The method of claim 13, wherein the at least one non-root node outputs a second data set, and wherein the second data set comprises the first data set plus at least one new column added to the plurality of columns of the first data set.

15. The method of claim 1, further comprising:
computing, by the processing system, a unique count of entities reported by each node of the funnel analysis query, including the root node and the at least one non-root node; and
constructing, by the processing system, a graphic representation of a funnel resulting from the unique count.

16. The method of claim 15, wherein the graphic representation is selected from at least one of: a Sankey diagram and a sunburst diagram.

17. The method of claim 1, wherein the electronic data set is distributed across a plurality of electronic data sources.

18. The method of claim 1, wherein the root node is an only node of the plurality of nodes that is associated with a fixed time range.

19. A non-transitory computer-readable medium storing instructions which, when executed by a processing system including at least one processor, cause the processing system to perform operations, the operations comprising:
defining a root node for a funnel analysis query of an electronic data set, wherein the funnel analysis query is structured as a directed acyclic graph comprising a plurality of nodes including the root node, wherein the root node comprises a point of origin for at least one funnel of the funnel analysis query, and wherein the root node is constructed to detect a first event that took place within a first time range that is fixed;
defining at least one non-root node that is connected to the root node, wherein the at least one non-root node is constructed to detect a second event that took place within a second time range that is defined relative to the first time range;
performing a funnel analysis on the electronic data set using the funnel analysis query including the root node and the at least one non-root node, wherein the funnel analysis tracks an entity through a sequence of events including the first event and the second event; and
initiating a remedial action with respect to the entity, in response to a result of the funnel analysis.

20. A device comprising:
a processing system including at least one processor; and
a non-transitory computer-readable medium storing instructions which, when executed by the processing system, cause the processing system to perform operations, the operations comprising:
defining a root node for a funnel analysis query of an electronic data set, wherein the funnel analysis query is structured as a directed acyclic graph comprising a plurality of nodes including the root node, wherein the root node comprises a point of origin for at least one funnel of the funnel analysis query, and wherein the root node is constructed to detect a first event that took place within a first time range that is fixed;
defining at least one non-root node that is connected to the root node, wherein the at least one non-root node is constructed to detect a second event that took place within a second time range that is defined relative to the first time range;
performing a funnel analysis on the electronic data set using the funnel analysis query including the root node and the at least one non-root node, wherein the funnel analysis tracks an entity through a sequence of events including the first event and the second event; and
initiating a remedial action with respect to the entity, in response to a result of the funnel analysis.
